(19) United States
(12) Patent Application Publication
(10) Pub. No.: US 2012/0096371 A1
(43) Pub. Date: Apr. 19, 2012

(54) SYSTEM AND METHOD FOR ONLINE INTERACTIVE RECORDING STUDIO

(75) Inventor: Joseph J. D'Anna, Lucca (IT)

(73) Assignee: Be In, Inc., New York, NY (US)

(21) Appl. No.: 13/193,894

(22) Filed: Jul. 29, 2011

Related U.S. Application Data
(60) Provisional application No. 61/370,024, filed on Aug. 2, 2010.

(51) Int. Cl. G06F 15/16; G06F 3/01

(52) U.S. Cl. 715/756; 709/205

(57) ABSTRACT

The present invention relates to a system and method for an on-line music studio. More particularly, the present invention relates to the management and synchronization of online musical tracks created by musicians and enthusiasts, especially ‘non-musicians’. The present invention provides an on-line forum and technical workspace where both new and experienced songwriters, musicians, and producers of all experience levels and backgrounds can come to integrate and synchronize separate musical tracks from multiple, geographically distant, users in real time, into a single complete musical composition.

### CROSS-REFERENCE TO RELATED APPLICATIONS

This application claims the benefit of U.S. patent application Ser. No. 61/370,024, filed Aug. 2, 2010, which is hereby incorporated by reference in its entirety.

### FIELD OF THE INVENTION

The present invention relates to the field of music recording and musical studio management. More particularly, the present invention relates to the management and synchronization of online musical tracks created by musicians and enthusiasts, especially ‘non-musicians’. As such, the present invention provides an on-line forum and technical workspace where both new and experienced songwriters, musicians, and producers of all experience levels and backgrounds can come together and collaborate on songs and projects in real time.

### BACKGROUND OF THE INVENTION

Musicians and non-musicians alike have been looking at online music collaboration as the next “killer-app”. Prior art network music performance spaces have been the source and continue to be the source, of several commercial endeavors.

These current and past efforts have significant drawbacks. An example of deficiencies that we perceive in prior art online music collaboration can be seen in the JamGlue software system provided by Jamglue.com. JamGlue provides a software music mixer that allows users to create, remix and add tracks to a project. A significant drawback of JamGlue can be appreciated when you consider that it lacks a network architecture to prevent signal latency. This results in an inability to collaborate or communicate in real time. Furthermore, the JamGlue solution provides little in the way of user tools designed to assist musicians to find collaborators.

Another example of prior art systems is the Indaba music platform, provided by indaba.com. The Indaba music platform provides the ability to use an online management system to download collaborative musical sessions into separately sourced multi-track audio software. However, the Indaba platform requires the use of expensive and complicated software modules located on a local computer. These software modules are accessible only to professional musicians or well-capitalized amateurs. As such, the software price and technical complexity becomes a barrier to amateur users.

Further drawbacks in the prior art limit the user's interactivity with other users. Prior art platforms require users to supply several individual non-standardized components in order to achieve the functionality of the present invention, such as discrete chat, video conferencing, on-line storage and mixing programs. Prior art platforms also require the use of local computer installed software modules to gain access to full mixer functionality. Additionally, the prior art fail to provide the audio integration and synchronization functions found in the present invention. The invention addresses at least one of these drawbacks in a system that can be accessed through clients distributed across the Internet and other computer networks.

### SUMMARY OF THE INVENTION

In accordance with a broad aspect of the invention, the present invention provides for an on-line interactive recording studio and meeting space (or forum) for musicians. In more particular aspects, the present invention provides a forum through which musicians can find other musicians who are currently on-line. In part, the present invention enables a project initiator or orchestrator to send synchronization information and musical tracks to other online musicians. The present invention also enables, in part, the orchestrator to solicit other musicians to join real time musical compositions. A system and method according to the invention can be configured to enable the creation of musical compositions involving multiple audio tracks in real time through an interactive recording studio application. The tracks can be controlled and orchestrated by a single user. Completed compositions can then be uploaded for community rating and approval.

The interactive recording studio and forum are hosted on-line and allow users to access them remotely, without the need to download or install any software. The advantages of this system are readily apparent. The present invention is adapted to enable a user (“orchestrator”) to access the online interactive recording studio and forum via a web portal. Through the forum, the orchestrator can locate other users, register an online presence, sample other musical compositions, and use the online recording studio. Access through the forum allows users to work and collaborate on musical compositions from anywhere there is an available network connection regardless of geographic distance or time zone.

The network-based application setup can have a wide variety of personal computing devices (portable computer, desktop, PDA, smart-phone or electronic tablet) accessing and using the system free of compatibility issues that result from combining software and hardware operating configurations to provide the same functionality as the invention described hereinbelow. Furthermore, remote access provides for less resource draw on a device and allows system resources to be freed for other tasks.

In an illustrative embodiment of the invention, an orchestrator can seek out other musicians listed and registered in the forum. The orchestrator can search the forum for active users matching the skill set, instrument type or temperaments desired and invite them to their personal interactive online studio. The interactive online studio has all the tools necessary to produce a collaborative musical composition at the professional level. Each user is capable of providing at least one musical track to the composition, either by playing a live instrument or a prerecorded musical element. Once the project session begins, the music tracks are selectively incorporated into a project mixer. Through the mixer, the orchestrator can integrate a selection of the live musical tracks and pre-recorded tracks or channels in real time, and generate a musical composition that is stored for editing or production.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail detailed description serve to explain the principals of the invention. In the drawings:

FIG. 1 is a schematic block diagram of a system according to one embodiment of the invention, highlighting certain interconnected modules thereof.

FIG. 2 is a conceptual diagram of a project creation application interface, highlighting certain functions that can be included in a system constructed in accordance with the invention.

FIG. 2A is a set of modules that cooperate to provide functionality to a user through an interface such as shown in FIG. 2, using a media server such as is a component of the system of FIG. 1.

FIG. 3 is an illustrative diagram of the invention, highlighting the interconnected modules of a system in accordance with the invention.

FIG. 4 is a flow diagram illustrating the various actions that an orchestrator can take when using a system constructed in accordance with the invention.

### DESCRIPTION OF ILLUSTRATIVE CERTAIN EMBODIMENTS OF THE INVENTION

By way of overview and introduction, the present invention concerns a system and method for an online recording studio and forum. The system is directed to assisting musicians to collaborate, create, manage, and produce online musical tracks. The system is further directed to an online forum for musicians to find collaborators, publically audition and interact socially. Through the online recording studio and forum, users are able to integrate and synchronize musical tracks from multiple geographically distant users into a single complete musical composition, in real time.

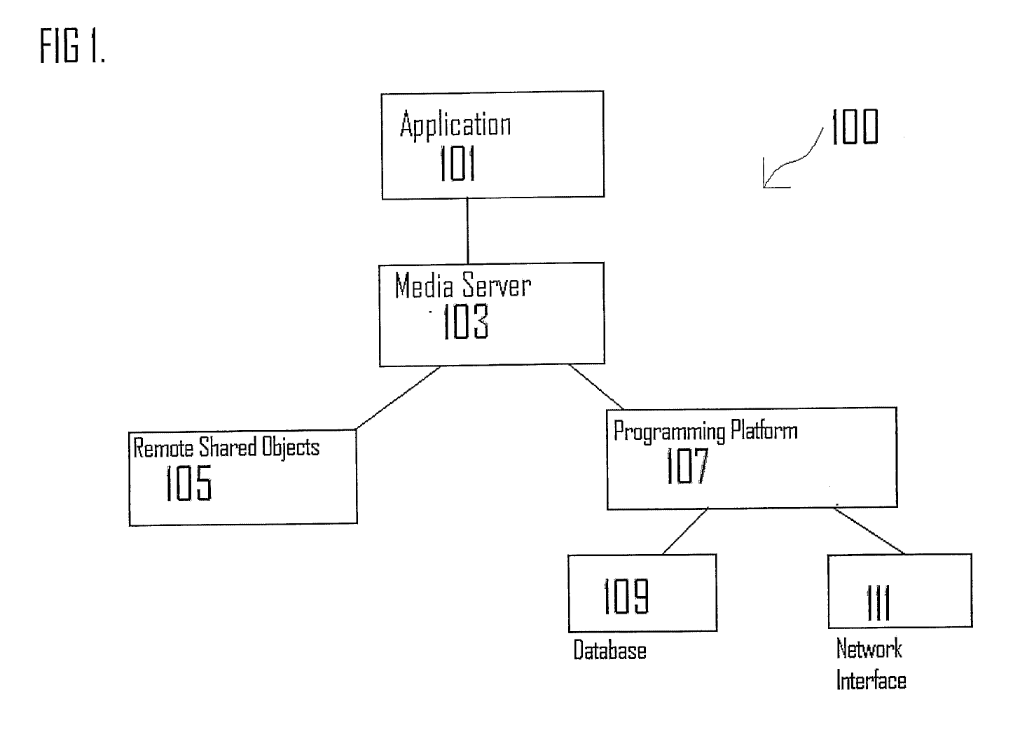

As seen in FIG. 1, the interactive online recording studio and forum comprise a system 100 . The system 100 uses bidirectional network communications to connect a server-based application (101) to a media server (103). The media server (103) is configured to connect to remote shared objects (105) (only one shown) and commonly used network programming platforms (107) and database (109) and network interface modules (111), e.g., Media Server Pro, Java, Mysql, Apache, Ruby on Rails, and other similar application programming interfaces and database management solutions. The interactive online recording studio and forum is characterized by broad adaptability to user configurations, multiple user inputs, and the freedom to share and re-use collaborative musical compositions. Musical collaborations and compositions are based on the Creative Commons licensing models, promoting the sharing and re-use of the music created, while still retaining fundamental attribution and other rights for the original artists.

The online interactive recording studio and forum is accessed by way of a web portal in a conventional manner, such as by using a Web browser program such as Mozilla's Firefox. The web portal offers a registered orchestrator access to a personalized online recording studio and forum, and the orchestrator can have a profile maintained by the media server 103 or in a database in communication therewith such as the database 109. The recording studio and forum are designed for simplicity. With just a few clicks it is possible to tap into thousands of music samples, record tracks with live instruments, vocal performances and edit those into musical collaborations through the use of professional-level editing tools.

The web portal provides access through standard Internet protocols to a forum that allows an orchestrator to begin a project, look for collaborators, check on past projects and interact socially with other users from around the world. In part, the portal maintains presence information on which users are logged in or are detected as having an “active” status (such as may result from any interaction with the portal with a prescribed, recent period of time). The forum is configured to allow the orchestrator to access any of these functions through a web-based interface, with no requirements for downloadable software. The forum provides each user with a personal hosted space to store musical elements (that is, songs, tracks, or snippets that are less than an entire track or song, and so on), as well as providing storage for composed compositions, an avatar or representative image of the user, messaging and electronic mail functions. Furthermore, the forum provides access to the orchestrator's stored personal profile space, lists of friends and collaborators, and community reputation.

Through the forum, the orchestrator can also upload pre-recorded musical elements from the orchestrator's local computer. The uploaded local computer tracks and elements can be provided to the forum for community review and critique or stored in orchestrator's personal storage space. The system 100 also foresees that users can upload any material recorded outside the online recording studio in formats such as MP3, WMA, or WAV files. As soon as any new sound file is uploaded to the studio, the material is automatically certified by the creation date and so-safeguarded and protected under copyright.

The forum also provides in part, searching capabilities for searching musical element databases for freely available user specified musical elements, such as through the interface 305 described below.

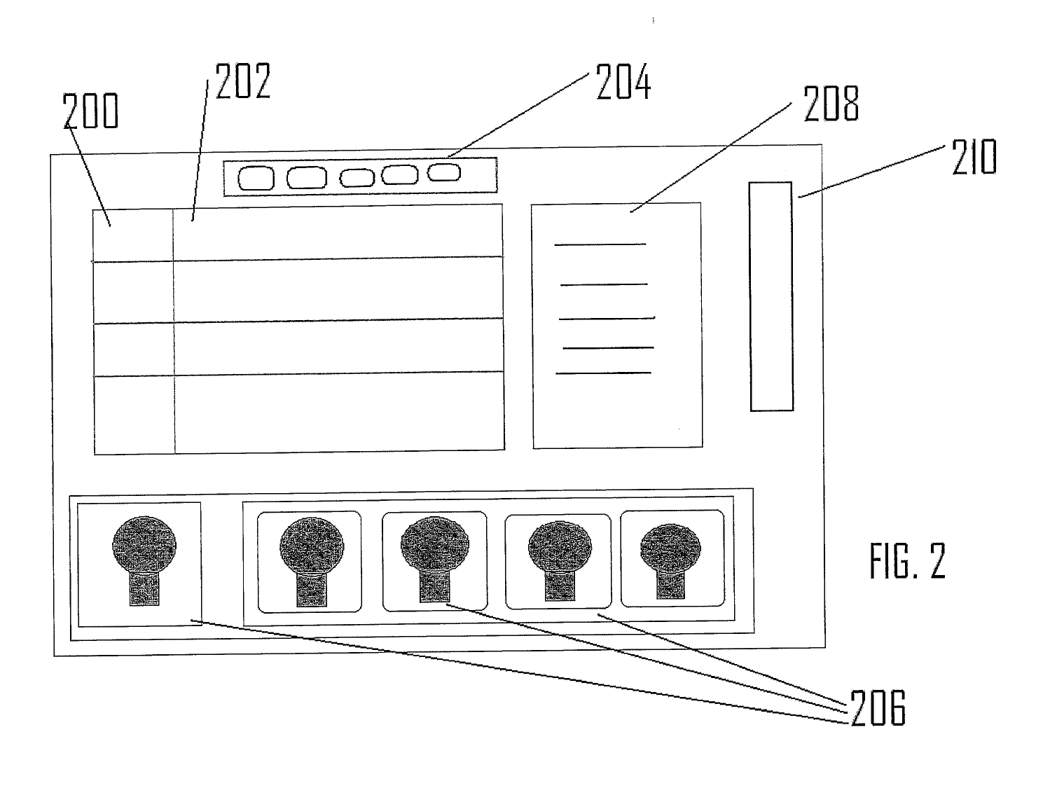

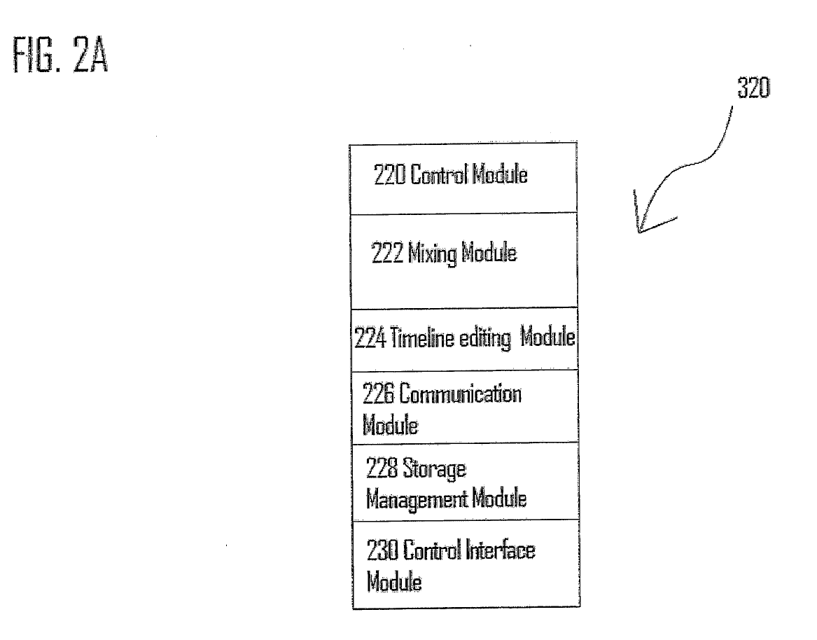

As seen in FIG. 2, a system in accordance with the present invention also provides, in part, for an interactive recording studio application. The system 100 provides a computer configured by code such as a software tool that enables music creation and manipulation, and which tool is accessible from the forum. The interactive recording studio user interface is configured to provide access to various music creation and editing functions via the interface 305.

The interactive recording studio application provides the user with access to: track or channel information and controls (200), a mixing timeline (202), timeline editing tools (204), audio and video communication to other users (206), the orchestrator's stored tracks or musical elements (208), and a general control interface (210). More specifically, as shown in FIG. 2A, a set of modules cooperate with one another to provide the information presented through the interface of FIG. 2. Thus, for example, there is a control module 220, a mixing module 222, a timeline editing module 224, a communication module 226, a storage management module 228, and a control interface module 230. Each of these modules can comprise hardware, code executing in a processor, or both, that configures a machines such as the media server 103 to implement the functionality described herein.

With further reference to FIG. 2A, the control interface module 230 includes instructions for enabling a user to access the functions of the online recording studio. The control functions can be implemented as discrete sub-modules providing the ability to start or stop a composition recording, invite collaborators to the on-line recording studio, access previously recorded compositions stored in a database, search and retrieve musical elements stored in a database, and access file, member and help functions. As such, the control interface module has control over at least file management and playback.

Mixing module 222 includes instructions for receiving live or stored audio data from the communication module or from a database. The mixing module is further configured to manipulate the parameters of the audio data, and operates on the audio data itself. The manipulation function of the mixing module can be implemented as discrete sub-modules to provide functions such as compression, analog to digital conversion, reverb, equalization, pan pots, fading, delay, level alteration, specialized sound effects or similar audio mixing function and providing the mixed tracks as a data to other modules. The mixing module receives input tracks from live sources, streamed data, or stored files and outputs a processed version of the input tracks in accordance with the settings made by the orchestrator.

Timeline editing module 224 includes instructions for controlling the location and duration of each individual track in the overall composition. The timeline editing module receives data corresponding to each track of the composition and is configured to alter parameters of each track such as position, duration and length. The timeline editing module can be implemented as discrete sub-modules configured to provide the specific parameter editing functions of selecting a section of a track, duplicating a track section, editing the duration of a track, moving the location of a portion of track to a different location within channel and providing the edited tracks as a data stream to other modules.

Communication module 226 includes instructions for receiving separate dedicated audio data streams from musical device interfaces, such as a MIDI interface, originating from the orchestrator or collaborator, and receiving separate audio visual data streams from connected audio visual devices such as a web-camera and microphone. The communication module can be implemented as discrete sub-modules configured to provide the specific communication functions of receiving musical instrument data steams; providing separate audio visual data streams for each collaborator connected audio visual device; and providing the audio data stream to the other modules and providing audio visual data streams to a user interface.

Storage management module 228 includes instructions for storing and retrieving data in the form of musical compositions, musical elements and user data in databases and providing that data to the system 100. The storage management module can be remote from the actual storage location of the tracks being created and operated upon by the orchestrator.

Control module 220 includes instruction for assigning each dedicated audio data steam to a dedicated audio channel and for manipulating the parameters of the channels while recording the composition. The manipulation functions can be implemented as discrete sub-modules with instructions for altering the volume or pitch of the audio stream, assigning unique identifiers to each audio track, removing tracks from the audio compilation and providing the edited tracks as a data stream to other modules.

As with the forum, interactive recording studio application is located and executed on a remote server. It is configured for access and compatibility with widely used web browsers and operating systems.

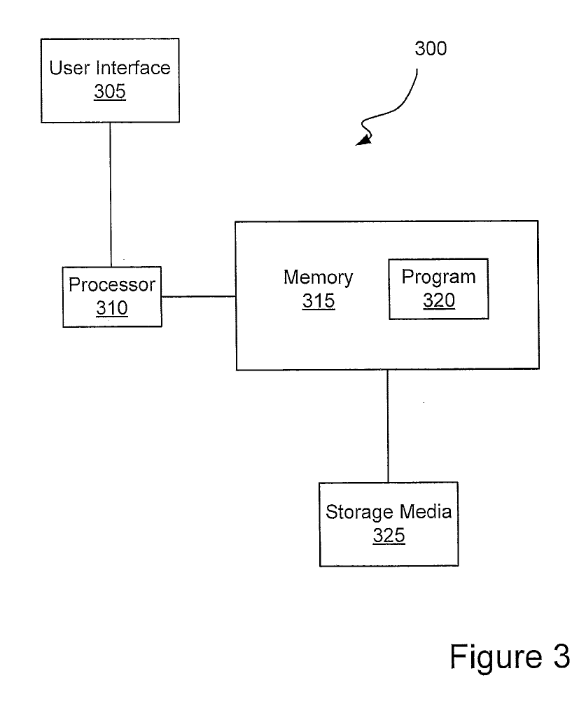

As shown in FIG. 3, a computer system 300 configured for employment of method 100. System 300 includes a user interface 305, a processor 310, and a memory 315. System 300 may be implemented on a general purpose microcomputer, such as one of the members of the Sun® Microsystems family of computer systems, one of the members of the IBM® Personal Computer family, one of the members of the Apple® Computer family, or a myriad other conventional workstation, desktop computer, laptop computer, a netbook computer, a personal digital assistant, or a smart phone. Although system 300 is represented herein as a standalone system, it is not limited to such, but instead can be coupled to other computer systems via a network (not shown).

Memory 315 is a memory for storing data and instructions suitable for controlling the operation of processor 310. An implementation of memory 315 would include a random access memory (RAM), a hard drive and a read only memory (ROM). One of the components stored in memory 315 is a program 320.

Program 320 includes instructions for controlling processor 310 to execute method 100. Program 320 may be implemented as a single module or as a plurality of modules that operate in cooperation with one another. Program 320 is contemplated as representing a software embodiment of the method described hereinabove.

User interface 305 includes an input device, such as a keyboard, touch screen, tablet, or speech recognition subsystem, for enabling a user to communicate information and command selections to processor 310. User interface 305 also includes an output device such as a display or a printer. In the case of a touch screen, the input and output functions are provided by the same structure. A cursor control such as a mouse, track-ball, or joy stick, allows the user to manipulate a cursor on the display for communicating additional information and command selections to processor 310.

While program 320 is indicated as already loaded into memory 315, it may be configured on a storage media 325 for subsequent loading into memory 315. Storage media 325 can be any conventional storage media such as a magnetic tape, an optical storage media, a compact disc, or a floppy disc. Alternatively, storage media 325 can be a random access memory, or other type of electronic storage, located on a remote storage system.

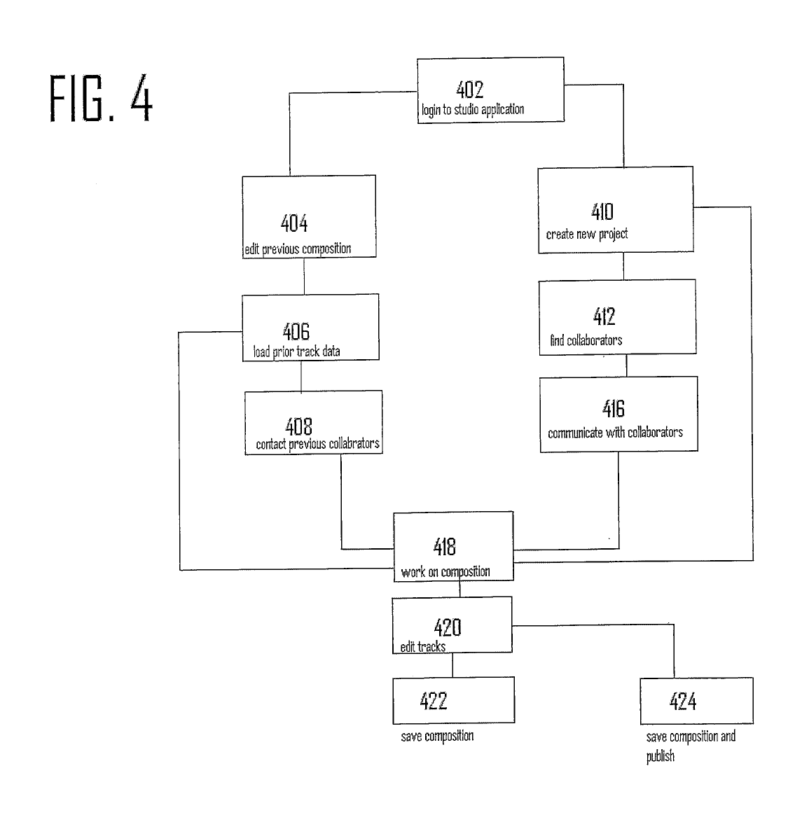

Referring now to the flow diagram of FIG. 4, various actions that can be taken by an orchestrator when creating a new project or re-opening and editing an existing project are described.

Once logged into the forum or running the interactive recording studio application as described above 402, the orchestrator has the option of starting a new project or retrieving an existing project previously stored in a database.

If the orchestrator elects to edit a previous composition as indicated by the right branch in the process flow diagram 404, all previous track information, collaborator information and data is loaded in the online studio 406. The orchestrator also has the option of contacting the previous collaborators 408 and informing them that that the prior project has been reopened and may offer them the opportunity to collaborate on the saved composition, or the orchestrator can edit the project without the input of the collaborators and immediately begin to work on the composition 418

Upon creating a new project, as indicated by the left branch in the process flow diagram 410, an orchestrator can invite a number of other users to contribute and collaborate with the orchestrator on a musical composition 412, or immediately begin to work on a composition 418. The project creation program provides a simple and intuitive layout, such as illustrated in FIG. 2, making it so that no prior knowledge in the musical engineering field is required by the orchestrator.

The orchestrator can search the forum to find a specific musician that fits the needs of the conceived composition, as indicated at step 412. The search result will be ranked according to the orchestrator's search criteria and provide a pre-recorded audio audition of the musicians skill and ability. The orchestrator can select an available musician and invite them to the open project or suggest the formation of a new project. If a preferred musician is unavailable the orchestrator can send a message or invitation to join a project at a later date.

Upon selecting a number of collaborators as indicated in step 412, the interactive recording studio application provides for the orchestrator and collaborators to communicate via audio-visual means (416) to arrange roles and for general administrative purposes. The interactive recording studio application provides network stability sufficient for each separate user to communicate while contributing. For example, if the users are equipped with web cameras, microphones or other communication devices, the users can communicate in real time. The orchestrator begins the composition 418 and incorporates the orchestrator's contributions and the collaborators contributions into the mixing timeline (202). The contributions can be in the form of a live performance uploaded in real time, or a pre-recorded musical element. Each user can access all the uploaded data for the active project, as well as to communicate with any other member in the project during the project duration.

The orchestrator can use the mixing timeline (202), which is configured to display the different tracts and channels as well as track editing tools (204), to control the form of the composition. Each displayed track in the mixing timeline (202) relates to a different user or pre-selected element, and can be manipulated by the orchestrator. The track editing tools (204) gives the orchestrator the ability to add, subtract, manipulate, manage, rearrange or otherwise edit 420 the tracks in the timeline (202), in real time. Furthermore, the present invention envisions uploading 422 all the timeline data along with the final composition to orchestrator's private user storage (208) for future retrieval. All data saved during a session is accessible by all of the contributors to the project. However, permission levels, upload privileges and publishing access are restricted to the orchestrator.

The orchestrator can chose between saving the project in a user specific on-line storage space that is accessible by only by the interactive recording studio or the user can publish the composition 424 in the social network portion of the forum. When the song is open to public judgment any user can listen to it and comment on it in the forum. Furthermore, completed compositions can form the basis of portfolios or audition files for all the collaborators who contributed to the project. This last option is still the orchestrator of the project's prerogative; other collaborators will be always able to save the song in their own project creation program, but not to publish it. In addition the compositions are instantly registered within the databases, and digital rights management protections are automatically applied to all completed compositions. All the material registered and published in online recording studio will not be allowed to be downloaded as MP3 or exported in any other way from the forum or databases.

The present invention also requires that any user, even the orchestrator, owns the copyright for all the material used in a project. The project creation application is also envisioned as having the ability to restrict compositions it determines are subject to copyright. In will not accept any material under copyright of any kind.

The present invention forum also provides options for a user who is not currently in a project but wishes to join a project in progress. These “out of session” users can search for active sessions among different styles and skill levels. In the search results provided by the forum, a listing of all the open studios is arranged by user selected criteria. The search results provide an image or avatar assigned to the specific project, the name of the project, the description, the musical genre, the needs of the orchestrator of the project, the stylistic or conceptual influences, the date of creation, the avatars of all the participants of the session, and a brief musical preview of the composition in progress. Additionally the search results will show the number of channels occupied in the project creation program and number of hours the project has been open. Out-of-session users can request entry to the project or suggest beginning a new session in their own project creation application. The project creation application is configured so that the orchestrator of a project holds the power to accept or reject a request of collaboration and can always remove any musician whenever unsatisfied with the development of the recording.

The present invention forum also envisions a database providing the name of any published musician or musical group along with the name of the song and the name and logo of an eventual record label affiliation. Any user will be able to rank songs through a rating system. The more the song is listened to, the higher the song will be automatically ranked in the forum database.

It is possible to envision all of the disclosed features and capabilities of the present invention as software modules. These software modules are stored as computer code and are executable by a processor or computer system.

The methods described herein have been indicated in connection with flow diagrams that facilitate a description of the principal processes; however, certain blocks can be invoked in an arbitrary order, such as when the events drive the program flow such as in an object-oriented program. Accordingly, the flow diagram is to be understood as an example flow and that the blocks can be invoked in a different order than as illustrated.

It should be understood that various combination, alternatives and modifications of the present invention could be devised by those skilled in the art. The present invention is intended to embrace all such alternatives, modifications and variances that fall within the scope of the appended claims.

While the invention has been particularly shown and described with reference to a preferred embodiment thereof, it will be understood by those skilled in the art that various changes in form and details may be made therein without departing from the spirit and scope of the invention.

What is claimed is:

1. A computer-implemented method for providing a collaborative music platform at a central machine between an orchestrator and one or more collaborators, the central machine having a processor, a memory, and a collaboration module stored in the memory and executing in the processor, the method comprising:
receiving an initiation request from the orchestrator, the initiation request comprising at least one of a request to initiate a new musical project and a request to retrieve an existing music project;
transmitting an invitation to the one or more collaborators, the invitation comprising a request for a collaborator to contribute to at least one of the new musical project and the existing music project;
providing the collaborative music platform at the central machine, the collaborative music platform comprising a collaboration interface between the orchestrator and the one or more collaborators;
receiving one or more musical elements at the central machine through the collaborative music platform, the musical elements originating at at least one of the orchestrator and the one or more collaborators;
combining the one or more musical elements with the collaboration module, thereby generating a finished musical work; and
publishing the finished musical work.

2. The method of claim 1, further comprising:
receiving a collaborator search query from the orchestrator, the collaborator search query comprising one or more collaborator search criteria; and
returning one or more search results to the orchestrator, the search results comprising profiles of one or more collaborators that conform to the one or more collaborator search criteria.

3. The method of claim 1, further comprising eliciting one or more opinions of the finished music work from one or more music listeners.

4. The method of claim 1, wherein the orchestrator and the one or more collaborators are in simultaneous communication with the collaborative music platform.

5. The method of claim 1, wherein the orchestrator and the one or more collaborators are in sequential communication with the collaborative music platform.

6. The method of claim 1, wherein the collaboration interface includes a communication forum for real-time communication between one or more of the orchestrator and the one or more collaborators.

7. The method of claim 6, wherein the real-time communication comprises two-way video communication.

8. The method of claim 1, wherein the music elements comprise one or more video elements.

9. A collaborative music system comprising:
a processor;
a control circuit operatively connected to the processor;
a memory operatively connected to the control circuit and accessible by the processor;
a collaboration module stored in the memory and executable in the processor; and
a communication interface operatively connected to the control circuit and configured to coordinate communications between an orchestrator and one or more collaborators;
wherein the collaboration module, when executed by the processor, configures the control circuit to:
receive an initiation request from the orchestrator at the communications interface, the initiation request comprising at least one of a request to initiate a new musical project and a request to retrieve an existing music project;
transmit an invitation to the one or more collaborators, the invitation comprising a request for a collaborator to contribute to at least one of the new musical project and the existing music project;
provide a collaborative music platform, the collaborative music platform comprising a collaboration interface between the orchestrator and the one or more collaborators;
receive one or more musical elements, the musical elements originating at at least one of the orchestrator and the one or more collaborators;
combine the one or more musical elements with the collaboration module to generate a finished musical work; and
publish the finished musical work.
